(19) United States
(12) Patent Application Publication
(10) Pub. No.: US 2007/0299844 A1
(43) Pub. Date: Dec. 27, 2007

(54) Method and apparatus for obtaining information based on user's access rights

(76) Inventor: Timothy C. Pepper, Tigard, OR (US)

Correspondence Address: LAW OFFICES OF MICHAEL DRYJA, 1474 N COOPER RD #105-248, GILBERT, AZ, 85233, US

(21) Appl. No.: 11/426,314

(22) Filed: Jun. 25, 2006

(51) Int. Cl. G06F 17/30

(52) U.S. Cl. 707/9

(57) ABSTRACT

Information is searched for in response to receiving a query from a user requesting the information. However, the information located is inaccessible by the user due to the information requiring access rights that the user does not have. Therefore, related information requiring access rights that the user does have is searched for and returned to the user for viewing by the user. The information may be stored in a first data store to which the user does not have access rights, and the related information may be stored in a second data store to which the user does have access rights. The information and the related information may be stored in the same data object, which includes first data representing the information and the access rights that the user does not have, and second data representing the related information and the access rights that the user does have.

### FIELD OF THE INVENTION

The present invention relates generally to searching for information requested by a user, and more particularly to searching for related information where the requested information requires access rights that the user does not have.

### BACKGROUND OF THE INVENTION

For a long time now, information has been stored electronically by organizations and other entities. Electronic storage of information is advantageous in that it is usually more readily accessible than information stored in more traditional formats, such as on paper. Thus, a given user may be able to locate desired information by retrieving it using his or her computing device.

One common way to locate information is to use a search engine to search for the information. Typically, a user generates a query, which may be a Boolean query in which search terms are separated by Boolean operators like OR, AND, and so on, or the query may be a simple list of search terms that are to be located. The query may further be a natural language query in the form of a question like “What does the project XYZ entail?” or a statement like “Give me all the financial information regarding the project XYZ.”, which is then parsed using a natural language interpreter. The query may be another type of query as well.

In response to the query, the requested information is attempted to be located, and when found, is returned to the user for viewing by the user typically at the same computing device at which the user originated the query. This is how Internet search engines operate for instance. A user types in one or more search terms, and then the information containing these search terms are returned to the user.

However, in the context of organizations and other entities, much information may be restricted by access rights. For instance, confidential information may require that users have elevated access rights in order to retrieve and view the information. Less confidential information may have access rights associated therewith that allow a larger group of user to retrieve and view the information.

Searching for information that is restricted by access rights is more difficult to achieve. For example, a user may request information that requires access rights that the user does not have. In response, the user may be notified that the requested information does not exist, even though it does, and although the user does not have the access rights needed to view the information. Alternatively, the user may be notified that he or she does not have sufficient access rights to view the information.

In these types of situations, users can be stymied by their inability to view the information that they desire. Even though there may be related information that requires access rights that the user does indeed have, such related information is not returned to the user as satisfying his or her query, because there is better, more specific information that is available but which the user cannot view due to elevated access rights. As such, users may not be able to retrieve the information that they desire.

For these and other reasons, there is a need for the present invention.

### SUMMARY OF THE INVENTION

The present invention relates to searching for related information where a user does not have access rights to requested information. A computer-implemented method of one embodiment of the invention searches for information in response to receiving a query from a user requesting the information. However, the information located is inaccessible by the user due to the information requiring access rights that the user does not have. Therefore, related information requiring access rights that the user does have is searched for and returned to the user for viewing by the user.

A computer-implemented method of another embodiment of the invention organizes information over a number of levels of abstraction within a data object. A number of levels of access rights are associated with the levels of abstraction within the data object. Each level of abstraction that is more specific than another level of abstraction has associated therewith more exclusive access rights than the other level of abstraction. The data object, including the information, the levels of information, and the levels of access rights, is stored. A query is received requesting the information from a user having predetermined access rights. In response, all the levels of abstraction of the information that the predetermined access rights of the user permit the user to view are returned, based on the levels of access rights associated with the levels of the information as stored within the data object.

A computerized system of an embodiment of the invention includes one or more data stores to store information, a communications component to receive queries requesting specific information from users, and a search component. The search component is to search the information stored in the data stores for the specific information requested by the users. Where the specific information requires access rights that the users do not have, the search component is to search for related information requiring access rights that the user does have and to return the related information located to the users for viewing by the users.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method according to an embodiment of the invention, and is suggested for printing on the first page of the patent.

FIG. 2 is a diagram of an exemplary computerized system, according to an embodiment of the invention.

FIG. 3 is a flowchart of a method more detailed than but consistent with the method of FIG. 1, according to an embodiment of the invention.

FIG. 4 is a diagram of a computerized system more detailed than but consistent with the computerized system of FIG. 2, according to an embodiment of the invention.

FIG. 5 is a flowchart of a method, according to another embodiment of the invention, and which may be employed in conjunction with the method 100 of FIG. 1.

FIG. 6 is a diagram of a computerized system more detailed than but consistent with the computerized system of FIG. 2, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

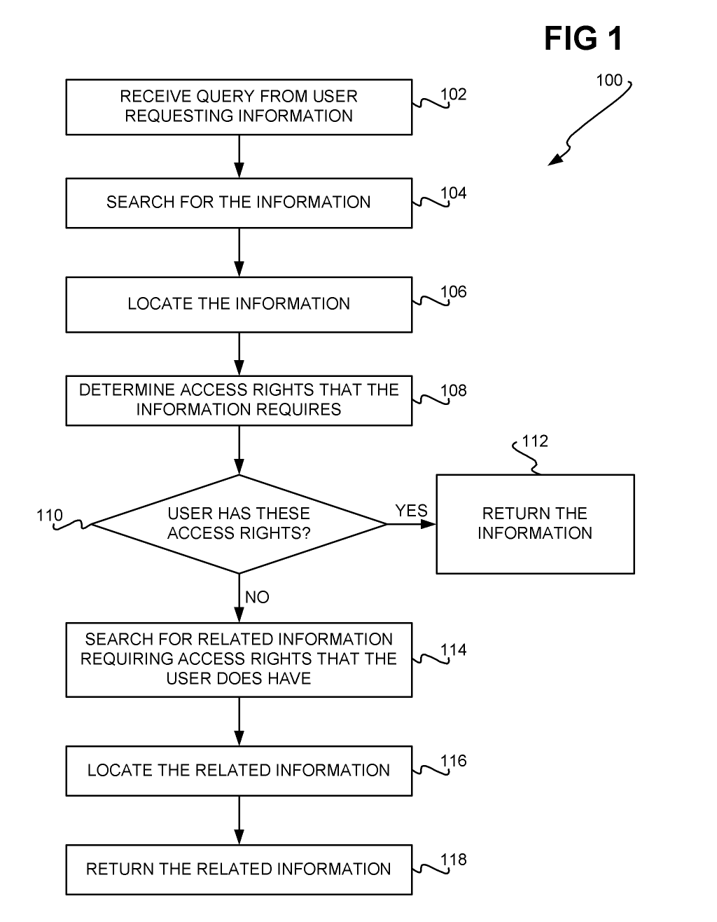

FIG. 1 shows a method 100, according to an embodiment of the invention. The method 100 may be computer implemented. For instance, at least some parts of the method 100 may be performed by a computing device and/or within the context of a computerized system. A particular exemplary computerized system is described in the next section of the detailed description. The method 100, as well as other methods of different embodiments of the invention, can be implemented as one or more computer programs that are stored on computer-readable media of articles of manufacture. Such computer-readable media may be tangible computer-readable media, like recordable data storage media.

A query is received from a user requesting information (102). The query may be a Boolean query in which search terms are separated by Boolean operators like OR, AND, and so on, or the query may be a simple list of search terms that are to be located. The query may further be a natural language query in the form of a question like “What does the project XYZ entail?” or a statement like “Give me all the financial information regarding the project XYZ.”, which is then parsed using a natural language interpreter. The query may be another type of query as well.

In response, the method 100 searches for the information (104), and is presumed for the purposes of FIG. 1 that it locates the information (106). The method 100 then determines the access rights that the information requires (108). Access rights are privileges that are granted to a user to access the information in question. Different types of access rights include read, write, and delete access rights. The information may have the access rights associated therewith by virtue of the information being a particular type of information, by virtue of the information being stored on a particular data store, and so on. The method 100 determines whether the user has the access rights required by the information (110). That is, the method 100 determines whether the user's access rights are sufficiently high to permit him or her to access and view the information.

If the user does have the access rights required by the information to view the information, then the information is returned to the user (112), so that the user can view the information. However, if the user does not have the access rights required by the information, then the method 100 searches for related information that requires the access rights that the user does have (114), and is presumed for the purposes of FIG. 1 that it locates this related information (116). As is described in more detail later in the detailed description, this related information may be stored on a different data store than the requested information, where the user has access rights to the data store storing the related information but not to the data store storing the requested information. Alternatively, this related information may be stored as part of the same data object as the requested information, where the requested information has higher access rights than the user has, but the related information does not.

The related information is then returned to the user (118), so that the user can view the related information. As an example of the performance of the method 100 of FIG. 1, a user may request information regarding a project having the codename “XYZ” from a corporate data repository. However, this project may be classified information within the company, and thus may have associated therewith access rights that the user does not have. For instance, specific details regarding the project, when it is anticipated to ship, how much money the company plans on making on the project, and so on, may constitute this requested information.

As such, the method 100 instead searches for related information on this project. This related information may be located within the corporate data repository, or within publicly available information stores on the Internet, for instance. The related information may be the general technology area with which the project is associated, and/or a general summary of the project that does not divulge the specific details regarding the project. Once this related information has been found, it is returned to the user as satisfying the user's query.

### Technical Background and Computerized System

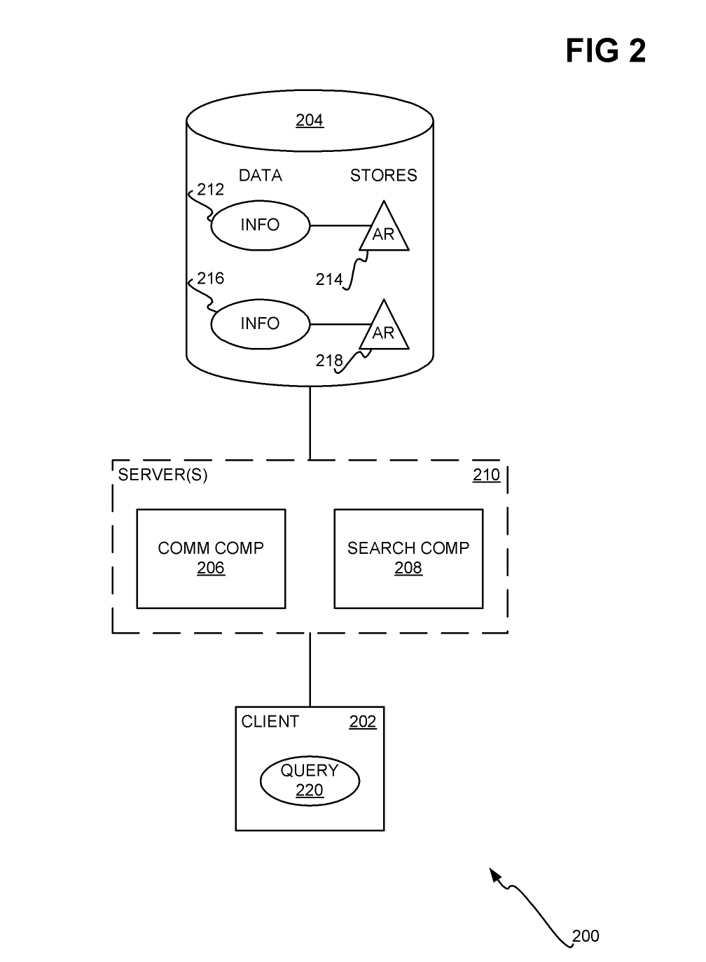

FIG. 2 shows an exemplary computerized system 200, according to an embodiment of the invention. The computerized system 200 is depicted as including one or more data stores 204 (where one is shown in FIG. 2 for illustrative convenience), and a communications component 206 and a search component 208 that may be part of one or more servers 210. The computerized system 200 may also include the client 202. As can be appreciated by those of ordinary skill within the art, the computerized system 200 may include other parts, in addition to and/or in lieu of those depicted in FIG. 2.

The data stores 204 are storehouses of data, such as the information 212 and the related information 216. The term data store is used in an encompassing and generic sense, and is intended to encompass all types of data storage devices. Where there is more than one such data store, the data stores 204 may be co-located or may be disposed at different locations. For instance, one of the data stores 204 may be a corporate data storage repository, whereas another data store may be considered as encompassing publicly available information on the Internet.

The information 212 and the related information 216 are depicted in FIG. 2 as representative of the types of information that the data stores 204 store. The information 212 can be specific information pertaining to one or more topics, keywords, subjects, and so on, whereas the related information 216 is information that is related to the information 212. For example, the related information 216 may be a general summary and/or an abstract of the information 212, while the information 212 may encompass more specific details on a given subject matter, or vice-versa.

The information 212 has associated therewith access rights 214, either implicitly or explicitly, whereas the information 216 has associated therewith different access rights 218, also either implicitly or explicitly. For example, consider the situation where both the information 212 and the information 216 are located on the same corporate data storage repository. The information 212 may have explicit access rights 214 that specify only executives are able to access the information 212. The information 216 may have explicit access rights 218 that specify that only executive and engineers are able to access the information 216. As such, the access rights 214 are more exclusive, or higher, than the access rights 218, which are less exclusive, or lower, than the access rights 214.

As another example, consider the situation where the information 212 is located on a corporate data storage repository, while the information 216 is located on a publicly accessible portion of the Internet. The information 212 as before may have explicit access rights 214 that specify only executives are able to access the information 212. By comparison, the information 216, since it is located on a publicly accessible portion of the Internet, has implicit access rights 218 that specify that anyone can access the information 216. The access rights 218 are implicit by virtue of anyone being able to access the information 216. In one embodiment, the terminology access rights encompass both explicit and implicit access rights, whereas in another embodiment, this terminology encompasses just explicit access rights.

A user generates a query 220 requesting information at a client 202, which may be a client computing device. The query 220 may include keywords, Boolean operators, and so on. For descriptive purposes, it is presumed that this query 220 requests the information 212. The client 202 sends the query 220 to the servers 210 to which the client 202 is communicatively connected. In one embodiment, the communications component 206 receives the query 220 from the client 202. The component 206 can be implemented in hardware, software, or a combination of hardware and software.

The communications component 206 conveys the query 220 to the search component 208 of the servers 210. The search component 208 may also be implemented in hardware, software, or a combination of hardware and software. The components 206 and 208 may be part of the same or different servers 210 in the example of FIG. 2. For example, the components 206 and 208 may be the same or different computer programs running on the same server 210. Alternatively, the components 206 and 208 may be the same or different computer programs running on two different servers 210 that are communicatively connected to one another. Each of the servers 210 may be a server computing device in one embodiment.

The search component 208 searches for the information requested in the query 220 within the data stores 204, with which the servers 210 are communicatively connected, by performing the method 100 of FIG. 1. Thus, where the user does not have the access rights 214 associated with the information 212, then the search component 208 instead searches for information related to the information 212 to which the user does have access rights. For example, the search component 208 may locate the information 216 as related to the information 212, and having the access rights 218 that the user does have. The search component then returns the related information 216 to the client 202 for viewing by the user of the client 202.

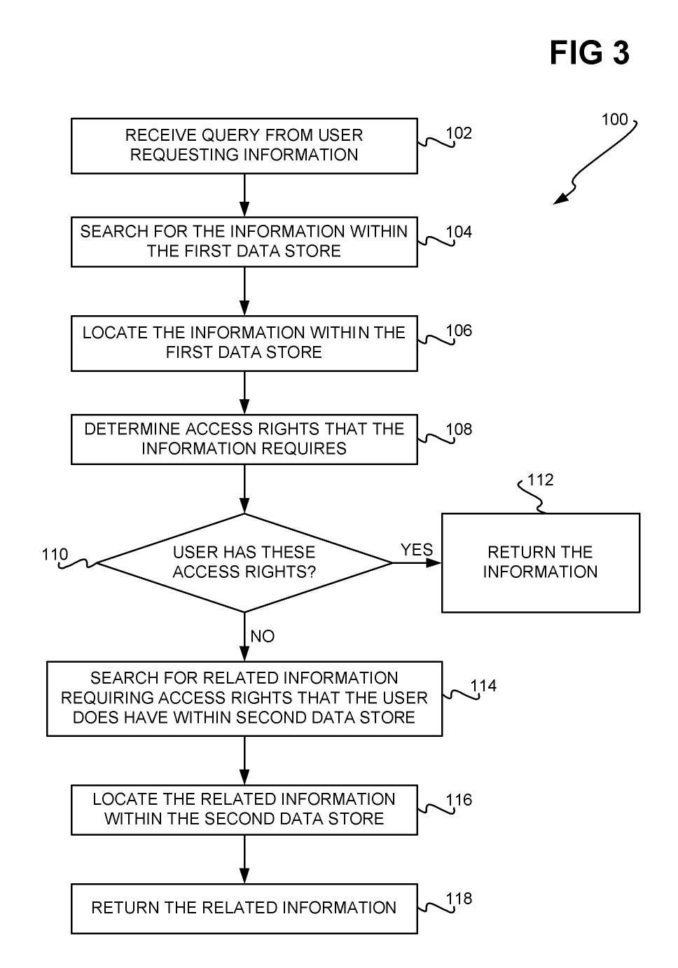

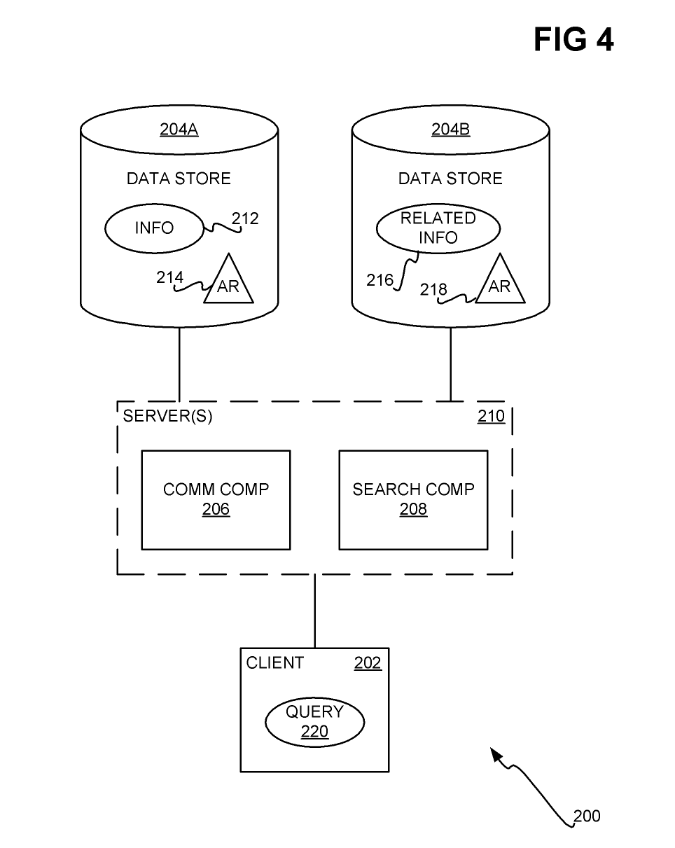

FIG. 3 shows the method 100, according to an embodiment of the invention, whereas FIG. 4 shows the computerized system 200, according to another embodiment of the invention. The method 100 of FIG. 3 is based on the more general method 100 of FIG. 1. The computerized system 200 of FIG. 4 is a particular implementation of the computerized system 200 of FIG. 2. The method 100 of FIG. 3 is described with reference to the computerized system 200 of FIG. 4.

The query 220 is received from a user of the client 202 (102), and which requests the information 212. For instance, the communications component 206 of the servers 210 may receive the query 220. In response, the search component 208 of the servers 210 searches for the information 212 requested within the query 220 within the first data store 204A (106). The data store 204A stores the information 212, and the data store 204A has the access rights 214, such that the information 212 has associated therewith the access rights 214 by virtue of being stored at the data store 204A.

The information 212 is thus located within the first data store 204A (106), and the access rights 214 that the information 212 requires are determined (108). Where the user has these access rights 214 (110), the information 212 is returned to the user (112), for viewing at the client 202. However, where the user does not have the access rights 214 (110), then the search component 208 searches for the related information 216 within the second data store 204B (114). The data store 204B stores the related information 216, and the data store 204B has the access rights 218, such that the information 216 has associated therewith the access rights 218 by virtue of being stored at the data store 204B. The user also has the access rights 218.

Therefore, the related information 216 is located within the second data store 204B (116). The search component 208 returns the related information 216 to the user (118), for viewing at the client 202. Because the user has the access rights 218, the user is permitted to view the related information 216, which is why the search component 208 returns the related information 216 to the user for viewing.

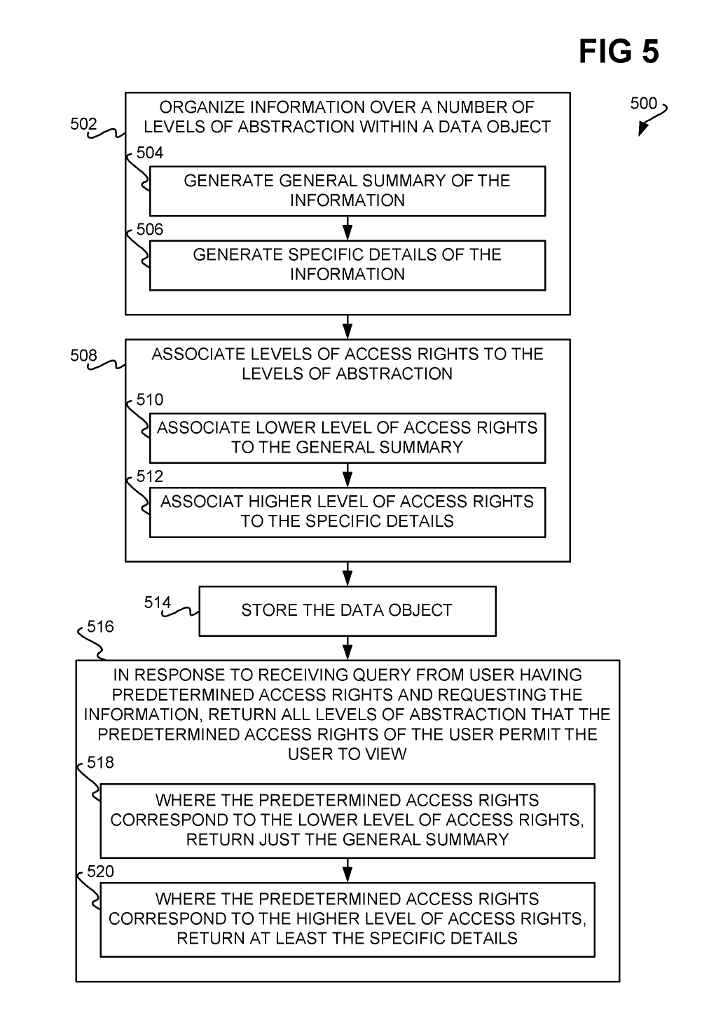

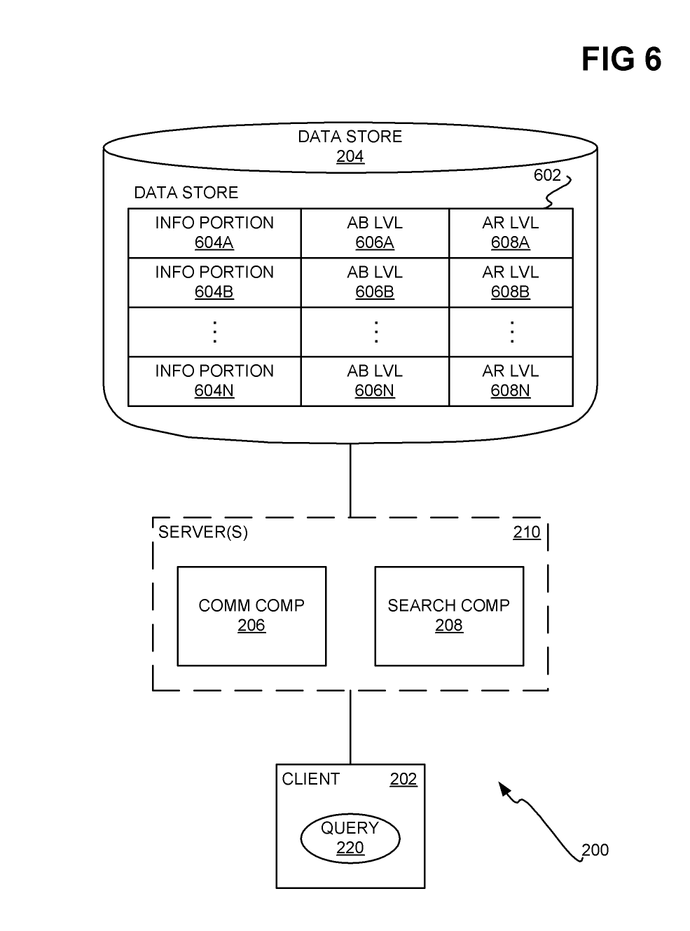

FIG. 5 shows a method 500, according to another embodiment of the invention, whereas FIG. 6 shows the computerized system 200, according to an embodiment of the invention. The method 500 of FIG. 5 can be utilized in conjunction with the method 100 of FIG. 1 or FIG. 3, as will be described. The computerized system 200 of FIG. 6 is a particular implementation of the computerized system 200 of FIG. 2. The method 100 of FIG. 5 is described with reference to the computerized system 200 of FIG. 6.

In the embodiment of FIG. 5, information is organized over a number of levels of abstraction within a data object (502). For example, in FIG. 6, the information encompasses information portions 604A, 604B, . . . , 604N, collectively referred to as the information portions 604. This information is organized over a number of levels of abstraction 606A, 606B, . . . , 606N, collectively referred to as the levels of abstraction 606, of the data object 602.

The levels of abstraction 606 can refer to different levels of specificity of the information organized thereover. For instance, the levels of abstraction 606 may range from most general to most specific, from least confidential to most confidential, and so on. Thus, the information portion 604A may represent the most general and least confidential portion of the information and is associated with the level of abstraction 606A, whereas the information portion 604N may represent the most specific and most confidential portion of the information and is associated with the level of abstraction 606N. In general, one or more of the levels of abstraction 606 are different than one or more other of the levels of abstraction 606. The information portion 604B may represent a portion of the information that is more general than the information portion 604N but more specific than the information portion 604A, and is associated with the level of abstraction 606B.

The data object 602 is a data structure that encompasses the information (that is, the information portions 604 as a whole), the levels of abstraction 606, and the levels of access rights 608A, 608B, . . . 608N, collectively referred to as the levels of access rights 608, and which will be described later in the detailed description. This data structure may be an object-oriented programming (OOP) language data object, such as a C++ programming language data object, a Java programming language object, and so on. In another embodiment, the data object 602 may be a data structure other than an OOP language data object.

Organizing the information over the levels of abstraction 606 within the data object 602 in part 502 of the method 500 of FIG. 5 may include the following. First, a general summary of the information is generated (504). Second, specific details of the information are generated (506).

For example, in FIG. 6, where there are just the two information portions 604A and 604B and just the two levels of abstraction 606A and 606B, the information portion 604A may be a general summary of the information, corresponding to a greatest level of abstraction 606A of the information. That is, the general summary is the most abstracted view of the information. The information portion 604B may be specific details of the information, corresponding to the least level of abstraction 606B of the information. That is, the specific details are the least abstracted view of the information.

As a concrete example, consider information regarding a corporate project. Specific details regarding the corporate project may include when the project is anticipated to ship, how much money the company plans on making on the project, and so on. The general summary of the information regarding the corporate project may include the general technology area with which the project is associated, and that otherwise does not divulge the specific details regarding the project. It is a more abstracted view of the information than the specific details of the information are.

Next, the method 500 of FIG. 5 associates levels of access rights to the levels of abstraction 606. For example, in FIG. 6, the levels of abstraction 606 are correspondingly associated with a number of levels of access rights 608A, 608B, . . . , 608N, collectively referred to as the levels of access rights 608, of the data object 602. The levels of access rights 608 can refer to different levels of access rights that the different levels of abstraction 606 require for access and viewing thereof In one embodiment, there may be at least three levels of access rights 608 corresponding to at least three levels of abstraction 606.

For instance, the levels of access rights 608 may range from least restrictive to most restrictive. Thus, the level of access rights 608A may correspond to the least restrictive access rights, such that the level of abstraction 606A of the information (the information portion 604A) is accessible by the largest number of users. By comparison, the level of access rights 608N may correspond to the most restrictive access rights, such that the level of abstraction 606N of the information (the information portion 604N) is accessible by the smallest number of users. In general, each level of abstraction that is more specific than another level of abstraction has associated therewith more exclusive access rights than the other level of abstraction does.

Associating the levels of access rights 608 within the data object 602 to the levels of abstraction 606 within the data object 602 in part 508 of the method 500 of FIG. 5 may include the following. First, a lower level of access rights is associated with the general summary of the information that has been generated in part 504 (510). Second, a higher level of access rights is associated with the specific details of the information that has been generated in part 506 (512).

For example, in FIG. 6, where there are just the two information portions 604A and 604B, just the two levels of abstraction 606A and 606B, and just the two levels of access rights 608A and 608B, the information portion 604A may be a general summary of the information, corresponding to a greatest level of abstraction 606A of the information. The information portion 604B may be specific details of the information, corresponding to the least level of abstraction 606B of the information. Therefore, the greatest level of abstraction 606A is associated with a lower level of access rights 608A, meaning that a larger number of users are able to access the level of abstraction 606A of the information (the information portion 604A). By comparison, the least level of abstraction 606B is associated with a higher level of access rights 608B, meaning that a smaller number of users are able to access the level of abstraction 606B of the information (the information portion 604B).

Next, the method 500 of FIG. 5 stores the data object 602 (514). For example, in FIG. 6, the data object 602 is stored within the data stores 204. It is noted that the data stores 204 may store other data objects, in addition to the data object 602. Each data object may contain a number of levels of abstraction of different information, such as information relating to different types of subject matter, as well as a number of levels of access rights associated with these levels of abstraction. In one embodiment, each data object may be stored as a self-contained securely encrypted object.

In response to receiving the query 220 from the user of the client 202 in FIG. 6, who has predetermined access rights, where the query 220 is for the information of the data object 602, the method 500 of FIG. 5 returns all the levels of abstraction 606 that the predetermined access rights permit the user to view (516). For example, in FIG. 6, the query 220 for the information of the data object 602 is sent from the client 202 to the communications component 206 of the servers 210. In response, the search component 208 of the servers 210 determines that the data object 602 of all the data objects stored in the data stores 202 stores the information requested within the query 220.

The search component 208 compares the predetermined access rights of the user of the client 202 that generated the query 220 with the levels of access rights 608 of the data object 602. For each level of access rights that the predetermined access rights of the user match, the search component 208 returns only the corresponding level of abstraction of the information of the data object 602 (the corresponding information portion of the data object 602). The search component 208 does not return any level of abstraction of the data object 602 associated with a level of access rights that does not match the predetermined access rights of the user. Stated another way, the search component 208 returns only those levels of abstraction 606 that are associated with the levels of access rights 608 that the user has.

For example, there may be five levels of abstraction 606 within the data object 602, and therefore five corresponding levels of access rights 608 within the data object 602, ordered from least restrictive to most restrictive on a scale from one to five. The user's predetermined access rights may specify that he or she can view any abstraction levels that have a level of access rights of three or less on this scale. As such, the first three more general levels of abstraction 606 are returned to the user for viewing. By comparison, the last two more specific levels of abstraction 606 are not returned to the user for viewing, because the user does not have sufficient access rights.

Returning all the levels of abstraction 606 that the predetermined access rights of the user permits the user to view in part 516 of the method 500 of FIG. 5 may include the following. First, where the predetermined access rights correspond to the lower level of access rights associated with the general summary of the information in part 510, then just this general summary is returned (518). However, where the predetermined access rights correspond to the higher level of access rights associated with the specific details of the information in part 512, then at least these specific details are returned (520). For instance, the general summary may also be returned, in addition to the specific details.

For example, in FIG. 6, where there are just the two information portions 604A and 604B, just the two levels of abstraction 606A and 606B, and just the two levels of access rights 608A and 608B, the information portion 604A may be a general summary, corresponding to a greatest level of abstraction 606A, and having the least restrictive level of access rights 608A. The information portion 604B may be specific details, corresponding to the least level of abstraction 606B, and having the most restrictive level of access rights 608B. Therefore, where the user's predetermined access rights correspond to the lower level of access rights 608A, just the greatest level of abstraction 606A of the information (the information portion 604A) is returned. Where the user's predetermined access rights corresponds to the higher level of access rights 608B, at least the least level of abstraction 606B of the information (the information portion 604B) is returned.

The method 100 of FIG. 1 that has been described may be employed in relation to the data object 602 that has been described in conjunction with FIGS. 5 and 6. For instance, the specific information requested by the user but that requires access rights that the user does not have may be the information portion 604B. The related information that is instead returned and that requires access rights that the user does have may be the information portions 604A. (In this example, the data object 602 has just two information portions 604A and 604B.)

The former information portion 604B is thus an abstraction of the information at the level of abstraction 606B associated with a level of access rights 608B that the user does not have. The data object 602 may be considered as having first data that represents this level of abstraction 606B and this level of access rights 608B. The latter information portion 604A is an abstraction of the information at the level of abstraction 606A associated with a level of access rights 608A that the user does have. The data object 602 may be considered as having second data that represents this level of abstraction 606A and this level of access rights 608A.

As such, when the specific information requested by the user is located within the level of abstraction 606B of the data object 602 having the level of access rights 608B that the user does not have, the search component 208 instead returns the level of abstraction 606A of the data object 602. This level of abstraction 606A corresponds to the related information that has been described, and is associated with the level of access rights 608B that the user does have. Therefore, the method 100 of FIG. 1, as well as the method 100 of FIG. 3, can be implemented in relation to data objects exemplified by the data object 602. However, the data object 602 can be used in methods other than the method 100 of FIG. 1 or FIG. 3, such as the method 500 of FIG. 5. Furthermore, the method 100 of FIG. 1 or FIG. 3 does not have to be used in conjunction with the data object 602.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof

We claim:

1. A computer-implemented method comprising:
searching for information requested by a user;
where the information located is inaccessible by the user due to the information requiring access rights that the user does not have,
searching for related information requiring access rights that the user has; and,
returning the related information located to the user.

2. The method of claim 1, wherein the information is searched for in response to receiving a query from a user requesting the information.

3. The method of claim 1, further comprising:
locating the information;
determining the access rights that the information requires; and,
determining whether the information located requires the access rights that the user does not have.

4. The method of claim 1, wherein searching for the information comprises searching for the information in a first data store, and wherein searching for the related information comprises searching for the related information in a second data store different than the first data store.

5. The method of claim 1, wherein the information and the related information are stored in a same data object, the same data object comprising first data representing the information and the access rights that the user does not have and second data representing the related information and the access rights that the user has.

6. A computer-implemented method comprising:
organizing information over a plurality of levels of abstraction within a data object;
associating a plurality of levels of access rights to the levels of abstraction within the data object, such that each level of abstraction has a different level of access rights;
storing the data object, including the information, the levels of abstraction over which the information is organized, and the levels of access rights to which the levels of abstraction having been associated; and,
in response to receiving a query requesting the information from a user having predetermined access rights,
returning all the levels of abstraction of the information that the predetermined access rights of the user permit the user to view, based on the levels of access rights associated with the levels of abstraction of the information as stored within the data object.

7. The method of claim 6, wherein each level of abstraction that is more specific than another level of abstraction has associated therewith more exclusive access rights than the other level of abstraction.

8. The method of claim 6, wherein organizing the information over the plurality of levels of abstraction comprises:
generating a general summary of the information; and,
generating specific details of the information.

9. The method of claim 8, wherein associating the plurality of levels of access rights to the levels of abstraction comprises:
associating a lower level of access rights to the general summary of the information, where the lower level of access rights permits all users to view the general summary of the information; and,
associating a higher level of access rights to the specific details of the information, where the higher level of access rights permits a small group of users to view the specific details of the information.

10. The method of claim 9, wherein returning all the levels of abstraction of the information that the predetermined access rights of the user permit the user to view comprises:
where the predetermined access rights correspond to the lower level of access rights, returning just the general summary of the information for viewing by the user; and,
where the predetermined access rights correspond to the higher level of access rights, returning at least the specific details of the information for viewing by the user.

11. The method of claim 6, wherein the information is organized over at least three levels of abstraction, such that at least three levels of access rights are correspondingly associated with the at least three levels of abstraction.

12. A computerized system comprising:
one or more data stores to store information;
a communications component to receive queries requesting specific information from users; and,
a search component to search the information stored in the data stores for the specific information requested by the users, and where the specific information requires access rights that the users do not have, to search for related information requiring access rights that the users has and to return the related information located to the users for viewing by the users.

13. The system of claim 12, wherein the one or more data stores comprises:
a first data store requiring first access rights for the users to access the first data store, where the users do not have the first access rights; and,
a second data store requiring second access rights for the users to access the second data store, where the users have the second access rights,
wherein where the specific information requested by the users is located in the first data store, the search component is to search the second data store for related information.

14. The system of claim 12, wherein the data stores are to store the information over a one or more data objects, each data object comprising:
a plurality of levels of abstraction of the information; and,
a plurality of levels of access rights associated with the levels of abstraction.

15. The system of claim 14, wherein where the specific information requested by the users is located within a level of abstraction of the information of a data object associated with a level of access rights that the users do not have, the search component is to return one or more other levels of abstraction of the information of the data object associated with one or more other levels of access rights that the users have, as the related information.

16. The system of claim 14, wherein the levels of abstraction of the information of each data object comprise a general summary of the information and specific details of the information, and the plurality of levels of access rights comprise a lower level of access rights associated with the general summary of the information and a higher level of access rights associated with the specific details of the information.

17. The system of claim 14, wherein the levels of abstraction of the information of each data object comprise at least three levels of abstraction, and the levels of access rights associated with the levels of abstraction comprise at least three levels of access rights.

18. An article of manufacture comprising:
a tangible computer-readable medium; and,
means in the medium for searching for specific information requested by a user, and where the specific information located requires access rights that the user does not have, searching for related information requiring access rights that the user does have, and returning the related information to the user for viewing by the user.

19. The article of manufacture of claim 18, wherein the means locates the specific information within a first data store, and where the first data store requires the access rights that the user does not have, the means searches for the related information requiring the access rights that the user does have.

20. The article of manufacture of claim 18, wherein the means locates the specific information within a most-specific level of abstraction of information of a data object, and where the most-specific level of abstraction is associated with the access rights that the user does not have, the means returns the related information as one or more more-general levels of abstraction of the information of the data object associated with the access rights that the user does have.
